(19) United States
(12) Patent Application Publication
(10) Pub. No.: US 2005/0226333 A1
(43) Pub. Date: Oct. 13, 2005

(54) Motion vector detecting device and method thereof

(75) Inventors: Mitsuru Suzuki, Anpachi-gun (JP); Shigeyuki Okada, Ogaki-shi (JP); Hideki Yamauchi, Ogaki-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/074,728

(22) Filed: Mar. 9, 2005

(30) Foreign Application Priority Data
Mar. 18, 2004 (JP) 2004-077563
Jan. 28, 2005 (JP) 2005-022103

(51) Int. Cl. H04N 7/12

(52) U.S. Cl. 375/240.16; 348/699; 375/240.24

(57) ABSTRACT

The present invention provides a technique for reducing a period of time required for detection of a motion vector. With a method for detecting a motion vector between an input image and a reference image used for a reference of the input image, first, a two-dimensional search region having a predetermined pattern is determined, and matching is computed between a coding target block in the input image and multiple blocks represented by multiple search points included in the search region in parallel. In a case wherein the evaluated computation results exhibit optimum matching results, the motion vector is determined based upon the computation results. In a case wherein the optimum solution has not been obtained, the search region for the next matching is determined based upon the evaluation results, and search is repeated.

### BACKGROUND OF THE INVENTION

1. Field of the Invention

The present invention relates to a motion vector detecting technique, e.g., a device having a function for detecting an interframe motion vector for coding motion images with an image coding method including an interframe prediction mode, a method thereof, and an image coding device using the motion vector detecting device.

2. Description of the Related Art

The MPEG-4 (Motion Picture Experts Group Phase 4), which is a standard of a compression coding method for motion images, employs motion compensation coding using motion vectors (see Japanese Unexamined Patent Application Publication No. 2003-87799, for example). With the motion vector tracking and detection described in Japanese Unexamined Patent Application Publication No. 2003-87799, tracking and detection of the optimum point is performed as follows. That is to say, first, the sum of the absolute differences is calculated for each search point in a predetermined search pattern including a given search origin. Next, the aforementioned search pattern is shifted such that the search point exhibiting a minimum sum matches the center of the next search pattern. The shifting of the pattern is repeated until the sum of the absolute differences obtained for the center search point is the minimum in those of all the search points in the next pattern thus determined. In this case, the center search point in the pattern thus obtained is determined as the optimum point. The motion vector tracking and detection disclosed in Japanese Unexamined Patent Application Publication No. 2003-87799 proposes a technique for setting a search-termination condition, e.g., limitation of the number of search times for each processing, thereby improving detection efficiency as well as suppressing redundant search for the motion vector.

With the motion vector tracking and detection as described above, tracking and detection are performed while shifting the search point to a next search point adjacent thereto, with a given search origin as a search start point, leading to a problem of long time for detecting the motion vector. On the other hand, with the aforementioned technique wherein search-loop termination conditions are set for reducing search time, in some cases, search is terminated with an undesired local minimum around the search origin, leading to reduced precision of motion-vector detection, resulting in an increased coding amount or reduced image quality.

### SUMMARY OF THE INVENTION

A first aspect of the present invention relates to a motion vector detecting device. The motion vector detecting device for detecting a motion vector between a first image and a second image serving as a reference image of the first image, includes multiple computation units for computing matching between a block included in the first image and blocks included in the second image, with the multiple computation units computing multiple matching steps at the same time in parallel.

Block matching may be performed between blocks based upon differences in the pixel values of the pixels included in the blocks, for example. The computation unit may compute an indicator wherein the smaller the difference in the pixel value therebetween is, the smaller the indicator is. For example, the computation unit may compute the sum of the squares of the differences in the pixel value of the pixel between the blocks, or may compute the sum of the absolute differences in the pixel value of the pixel therebetween. Such a configuration wherein the multiple computation units execute multiple matching computation steps at the same time reduces a period of time required for detection of the motion vector, thereby improving the processing speed of motion-image coding. Furthermore, such a configuration wherein multiple matching computation steps are executed in parallel reduces a period of time for memory access, thereby having further advantage of reducing the processing time.

With the motion vector detecting device, an arrangement may be made wherein each of the multiple computation units computes matching between the first image and a respective one of multiple blocks each of which is represented by a search point included in a two-dimensional search region having a predetermined pattern, with the motion vector detecting device further including: an evaluation unit for evaluating computation results obtained by the multiple computation units, and detecting a search point which exhibits optimum matching result; and a setting unit for setting search points for which the next matching is to be computed, based upon the evaluation result obtained by the evaluation unit. Such an arrangement wherein computation steps for the search points included in a two-dimensional search region are executed at the same time, and an optimum solution is detected for each search region, enables detection for a wider region in a shorter period of time than with conventional methods wherein the single search point is shifted step by step in a one-dimensional manner. This improves precision of motion-vector detection, as well as reducing processing time, thereby reducing the coding amount, and thereby improving the image quality.

With the motion vector detecting device, an arrangement may be made wherein the setting unit sets the next search region to a region including the search point which exhibits the optimum matching result, with the next search points being set to points included in the search region thus determined. This enables suitable detection while shifting a search region in a direction wherein there is a strong likelihood that the search point which exhibits optimum matching results will be detected, thereby improving precision of motion-vector detection, as well as reducing the processing time.

With the motion vector detecting device, an arrangement may be made wherein the setting unit sets the next search region by shifting the search region in a direction from the center point of the search region toward the search point which exhibits the optimum matching result. Furthermore, an arrangement may be made wherein the setting unit sets the next search region by shifting the search region in a direction from the search point which exhibits the optimum matching result in the previous computation toward the search point which exhibits the optimum matching result in the current computation. This improves precision of motion-vector detection.

An arrangement may be made wherein, in a case wherein the aforementioned evaluation unit has determined that the computation results satisfy predetermined condition as a result of evaluation of the computation results, the evaluation unit determines ending detection. For example, an arrangement may be made wherein, in a case wherein the search point which exhibits the optimum matching result in the previous computation matches the search point which exhibits the optimum matching result in the current computation, the evaluation unit determines ending detection. Furthermore, an arrangement may be made wherein, in a case wherein the indicator calculated in the matching computation is better than a predetermined threshold, the evaluation unit determines ending detection.

An arrangement may be made wherein the setting unit sets the search points based upon any one of: evaluation results evaluated by the evaluation unit in detection even further in the past than the immediately-previous detection; the motion vector of other block in the first image; the motion vector of the image even further in the past or in the future than the first image; and information regarding scrolling of the first image. Furthermore, an arrangement may be made wherein the setting unit determines the shape of the search region based upon any one of: evaluation results evaluated by the evaluation unit; the motion vector of other block in the first image; the motion vector of the image even further in the past or in the future than the first image; and information regarding scrolling of the first image. This enables higher-speed and higher-precision detection of the motion vector.

A second aspect of the present invention relates to an image coding device. The image coding device for coding motion images so as to create a coded data sequence comprises: a motion vector detecting unit for detecting a motion vector between a first image forming the motion images and a second image serving as a reference image of the first image; and a coding unit for coding the first image using the motion vector, with the motion vector detecting unit including multiple computation units for computing matching between the first image and blocks included in the second image, and with the multiple computation units computing multiple matching steps at the same time in parallel.

A third aspect of the present invention relates to a motion vector detecting method. The method for detecting a motion vector between a first image and a second image serving as the first image comprises: computing matching between the first image and multiple blocks, each of which is represented by a respective one of multiple search points included in a two-dimensional search region having a predetermined pattern included in the second image; estimating computation results obtained in the computation step so as to detect a search point which exhibits optimum matching result; and setting search points for the next matching computation based upon detection results obtained in the detection.

Note that any combination of the aforementioned components or any manifestation of the present invention realized by modification of a method, device, system, computer program, and so forth, is effective as an embodiment of the present invention.

Moreover, this summary of the invention does not necessarily describe all necessary features so that the invention may also be sub-combination of these described features.

### BRIEF DESCRIPTION OF THE DRAWINGS

FIG. 1 is a diagram which shows an overall configuration of an image coding device according to an embodiment of the present invention;

FIG. 2 is a diagram which shows an example of an input image;

FIG. 3 is a diagram which shows an example of a reference image;

FIG. 4 is a diagram which shows a specific example of twenty-five computation target macro blocks shown in FIG. 3;

FIGS. 5A and 5B are diagrams for describing a motion vector detecting method according to the embodiment;

FIGS. 6A, 6B, and 6C, are diagrams for describing a motion vector detecting method according to the embodiment;

FIG. 7 is a diagram for describing a motion vector detecting method according to the embodiment;

FIG. 8 is a diagram which shows a configuration of a motion vector detecting circuit according to the embodiment;

FIG. 9 is a diagram which shows a configuration of a computation unit according to the embodiment; and

FIG. 10 is a flowchart which shows a procedure of a motion vector detecting method according to the embodiment.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

An image coding device according to an embodiment of the present invention performs image coding stipulated by MPEG-4. With the image coding device according to the present embodiment, a motion vector is detected between a coding target image and a reference image by performing multiple block matching steps in parallel, thereby improving the processing speed. Furthermore, the present embodiment proposes a new motion vector detection method with higher detection precision by performing multiple block matching steps at the same time.

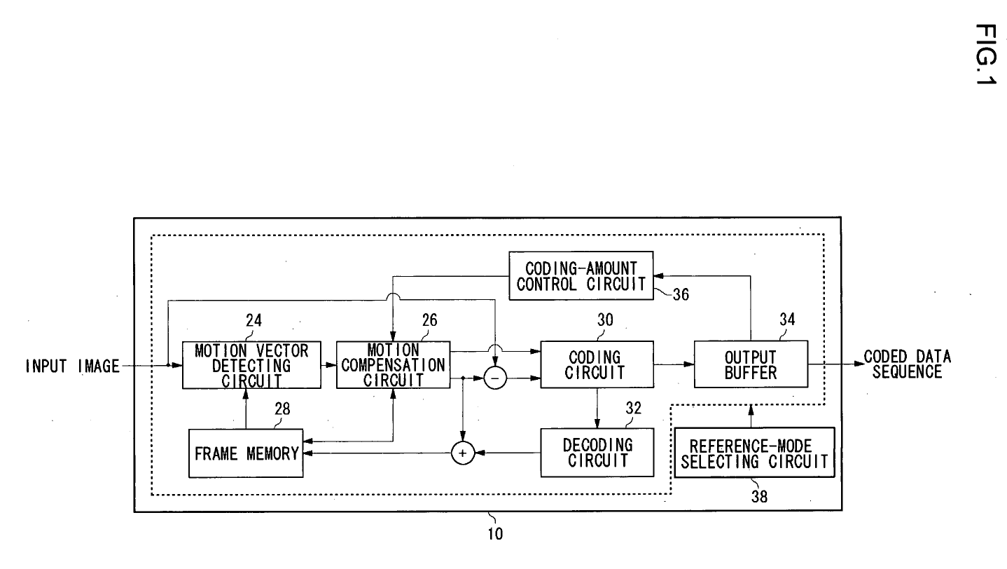

FIG. 1 shows an overall configuration of an image coding device 10 according to an embodiment of the present invention. The image coding device 10 includes a motion vector detecting circuit 24, a motion compensation circuit 26, frame memory 28, a coding circuit 30, a decoding circuit 32, an output buffer 34, a coding-amount control circuit 36, and a reference-mode selecting circuit 38. Part or all of the aforementioned components may be realized by hardware means, e.g., by actions of a CPU, memory, and other LSIs, of a computer, or by software means, e.g., by actions of a program or the like, loaded to the memory. Here, the drawing shows a functional block configuration which is realized by cooperation of the hardware components and software components. It is needless to say that such a functional block configuration can be realized by hardware components alone, software components alone, or various combinations thereof, which can be readily conceived by those skilled in this art.

The image (which will be referred to as “input image” hereafter) input to the image coding device 10 from an external device is transmitted to the motion vector detecting circuit 24. The motion vector detecting circuit 24 detects a motion vector by making comparison between the input image and an image (which will be referred to as “reference image” hereafter) stored in the frame memory 28 beforehand, serving as a reference for prediction. The motion compensation circuit 26 acquires the quantization step size for quantization of the image, from the coding-amount control circuit 36, and determines quantization coefficients and the prediction mode for the macro block. The motion vector detected by the motion vector detecting circuit 24, and the quantization coefficients and the macro block prediction mode determined by the motion compensation circuit 26, are transmitted to the coding circuit 30. Furthermore, the motion compensation circuit 26 transmits the differences between the predicted values and the actual values for the macro block, which is prediction deviation, to the coding circuit 30.

The coding circuit 30 performs coding of the prediction deviation using quantization coefficients, and transmits the quantized prediction deviation to the output buffer 34. Furthermore, the coding circuit 30 transmits the quantized prediction deviation and the quantization coefficients to the decoding circuit 32. The decoding circuit 32 performs decoding of the quantized prediction deviation based upon the quantization coefficients, creates a decoded image by adding the decoded prediction deviation and the prediction values received from the motion compensation circuit 26, and transmits the decoded image thus created, to the frame memory 28. The decoded image is transmitted to the motion vector detecting circuit 24, and is used as a reference image for coding the following images. The coding-amount control circuit 36 acquires how full the output buffer 34 is, and determines the quantization step size used for the next quantization based upon the degree how full the output buffer 34 is.

The reference-mode selecting circuit 38 selects the reference mode from the intra-frame prediction mode, the forward interframe prediction mode, and the bi-directional interframe prediction mode, and outputs the reference mode information thus determined, to other circuits.

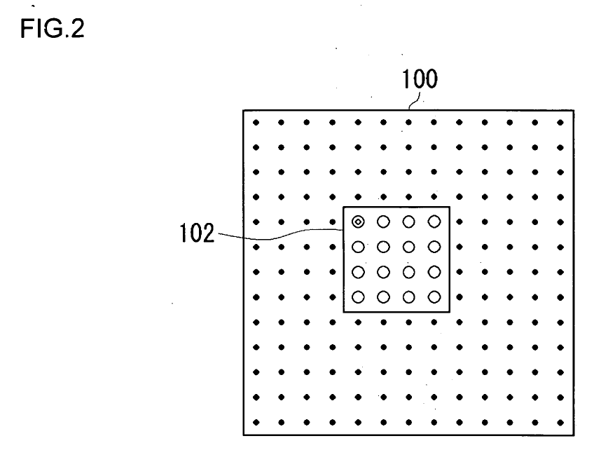

Description will be made regarding a motion vector detecting method according to the present embodiment with reference to FIGS. 2 through 6. The motion vector detecting circuit 24 detects the motion vector by block matching. That is to say, the motion vector detecting circuit 24 search the reference image for a macro block (which will be referred to as “prediction macro block” hereafter) which exhibits a minimum difference (prediction deviation) as to the macro block (which will be referred to as “coding target macro block” hereafter) in the input image, which is the current coding target. The present embodiment proposes an example of block matching wherein the sum of the absolute differences in the pixel value is calculated between the coding target macro block and each of the macro blocks prepared as prediction macro block candidates, and the macro block exhibiting a minimum sum of the absolute differences is determined as the prediction macro block corresponding to the coding target macro block. With the present embodiment, the vector which represents the motion from the position of the coding target macro block to the position of the prediction macro block thus detected is determined as the motion vector.

FIG. 2 shows an example of an input image 100. Let us say that the current coding target block is a macro block 102 in the shape of a square with a pixel size (width×height) of 4×4 in the input image 100. Note that, in general, while MPEG-4 employs the macro block with a pixel size (width×height) of 16×16, description will be made regarding an arrangement employing the macro block with a pixel size (width×height) of 4×4 for simplification of the drawing. Let us say that the position of the coding target macro block 102 is represented by the position of the upperleft pixel therein, and is indicated by a double circle.

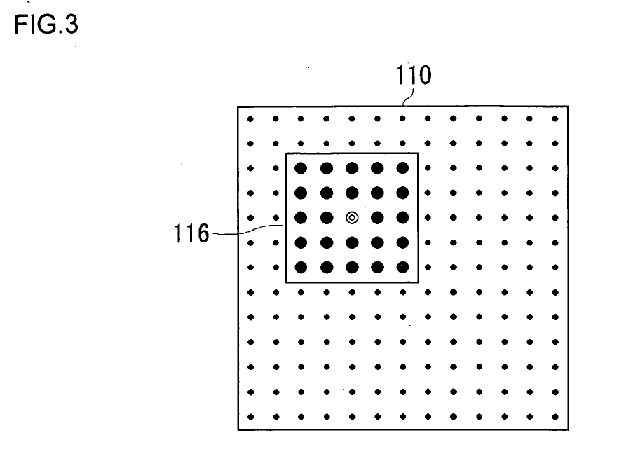

FIG. 3 shows an example of a reference image 110. With the present embodiment, twenty-five macro blocks (which will be simply referred to as “computation target macro block” hereafter”) are selected from the reference image 110 as the prediction macro block candidates, which are to be compared with the coding target macro block 102 in block matching, for detecting the motion vector required for coding the coding target macro block 102, and block matching is performed between the coding target macro block 102 and each of the twenty-five computation target macro blocks at the same time. FIG. 3 shows an example wherein, as a first stage, a square region 116 (which will be referred to as “search region 116” hereafter) is set with a pixel size (width×height) of 5×5, which has a center search point (which is indicated by a double circle) matching the position of the current coding target macro block 102 in the input image 100, and block matching is performed between the coding target macro block 102 and each of twenty-five macro blocks with a pixel size (width×height) of 4×4; each of the twenty-five macro blocks having an upperleft pixel of which position matches that of a respective one of the twenty-five pixels (each of which is indicated by a solid circle, and will be referred to as “search point” hereafter) in the search region 116.

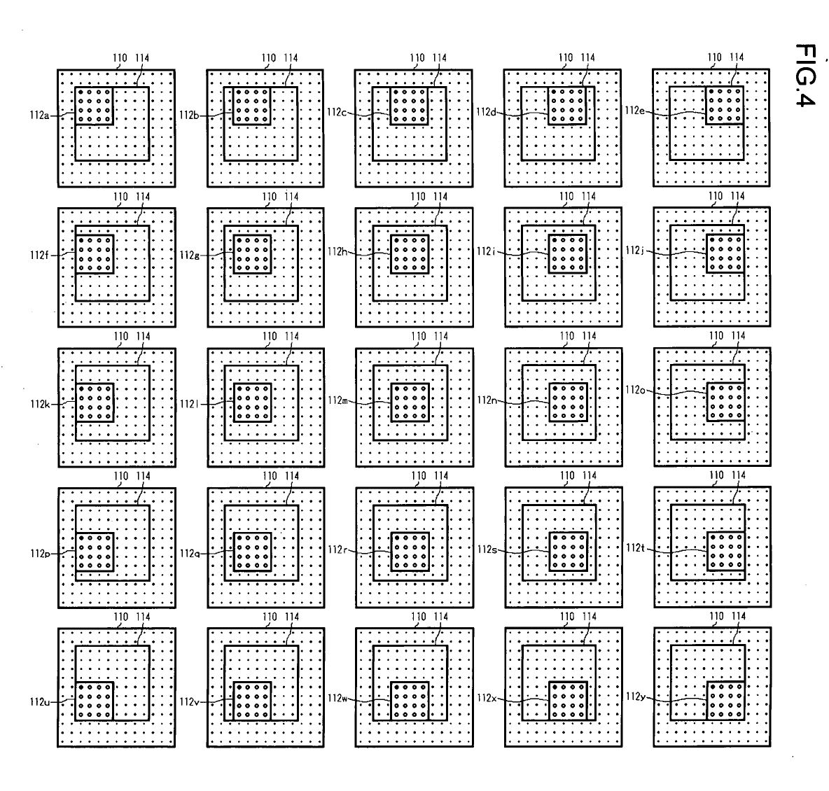

FIG. 4 shows an specific example of the twenty-five computation target macro blocks shown in FIG. 3. The motion vector detecting circuit 24 computes the difference data such as the sum of the absolute differences in the pixel value or the sum of the squares of the differences in the pixel value, between the coding target macro block 102 and each of the twenty-five computation target macro blocks 112a through 112y shown in FIG. 4, and detects the computation target macro block which exhibits the minimum difference data. At this time, all the pixels included in the computation target macro blocks 112a through 112y are within a region 114. Accordingly, with the difference computation according to the present embodiment, the pixel values of the pixels within the region 114 are temporarily stored in local memory, and computation with regard to the twenty-five computation target macro blocks is performed at the same time in parallel while sequentially reading out the pixel values from the local memory.

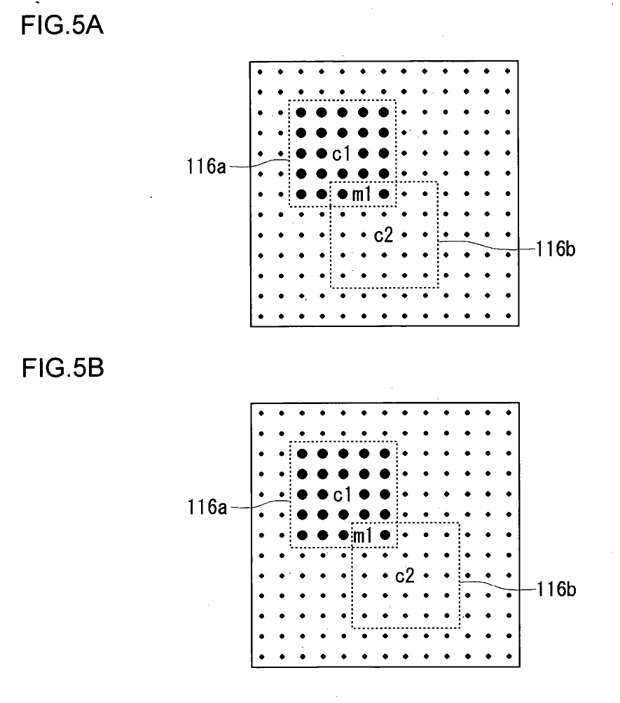

FIGS. 5A and 5B are diagrams for describing a motion vector detecting method according to the present embodiment. With the method according to the present embodiment for detecting the motion vector of the coding target macro block 102 shown in FIG. 2, block matching is repeated while shifting the search region 116 shown in FIG. 3, so as to detect the computation target macro block which exhibits a minimum difference as to the coding target macro block 102. Note that the position (which is represented by the upperleft pixel) of the computation target macro block 112 which exhibits a minimum difference in the n'th stage of block matching will be referred to as “n'th minimum point” hereafter, and will be denoted by reference character “mₙ” in the drawings. On the other hand, the center search point in the search region 116 in the n'th block matching will be referred to as “n'th center point”, and will be denoted by reference character “cₙ” in the drawings.

In FIGS. 5A and 5B, the position of the macro block which exhibits the minimum difference as to the coding target macro block 102, in the twenty-five computation target macro blocks 112 included in the first search region 116a shown in FIG. 3, i.e., the first minimum point, is denoted by reference character “m₁”. The motion vector detecting circuit 24 determines the second search region 116b based upon the aforementioned first computation results. With the present embodiment, the motion vector detecting circuit 24 determines the next search region including the minimum point thus computed in the current computation, based upon this minimum point.

FIG. 5A shows an example wherein the motion vector detecting circuit 24 determines the second center point c₂ which is shifted from the first center point c₁ by twice the vector c₁m₁ from the first center point c₁ to the first minimum point m₁. The motion vector detecting circuit 24 performs block matching for the twenty-five search points included in the second search region 116b thus determined. In this case, computation may be omitted for the computation target macro blocks 112 which have been already subjected to block matching in the first stage. With the present embodiment, the next search region 116 is obtained by shifting the current search region 116 in the direction from the center point of the current search region 116 to the current minimum point. This enables block matching while shifting the search region 116 in a suitable direction, i.e., in a direction wherein there is a strong likelihood that the prediction macro block will be detected, thereby enabling efficient detection of the prediction macro block in a short period of time. Furthermore, this suppresses the risk of ending detection with a local minimum point, thereby improving precision of motion-vector detection.

FIG. 5B shows an example wherein the motion vector detecting circuit 24 determines the second search region 116b of which the upperleft position matching the first minimum point m₁. With the aforementioned example, the region having the corner matching the minimum point obtained in the current computation is determined as the next search region 116. This suppresses redundant search as much as possible, thereby enabling block matching for a greater number of search points in a shorter period of time, i.e., enabling efficient detection of the prediction macro block in a short period of time. Furthermore, this suppresses the risk of ending detection with a local minimum point, thereby improving precision of motion-vector detection.

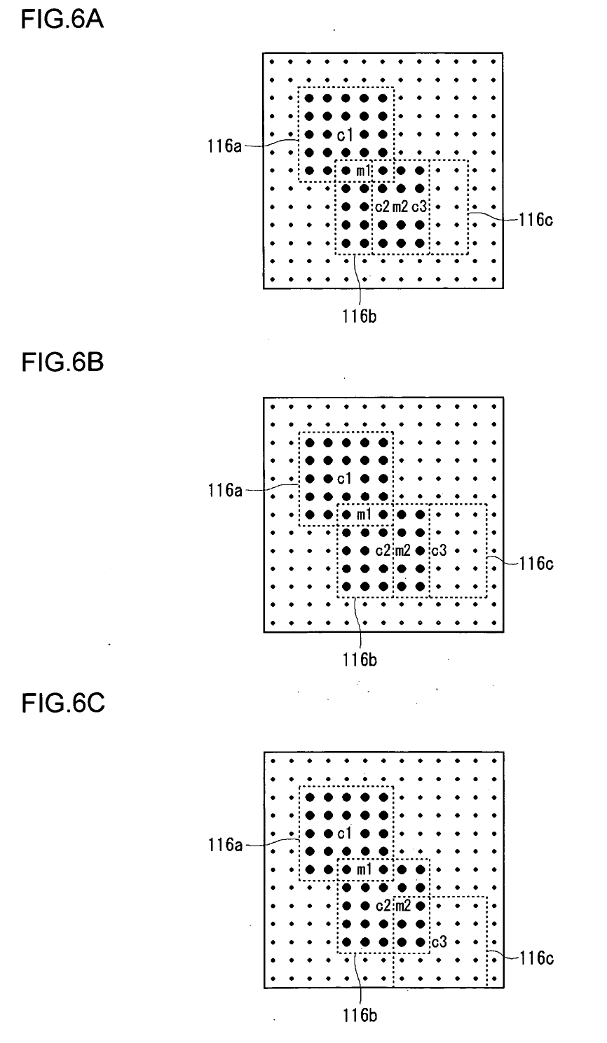

FIGS. 6A, 6B, and 6C, are also diagrams for describing a motion vector detecting method according to the present embodiment. In FIGS. 6A, 6B, and 6C, the position of the macro block which exhibits the minimum difference as to the coding target macro block 102, in the twenty-five computation target macro blocks 112 included in the second search region 116b shown in FIG. 5A, i.e., the second minimum point, is denoted by reference character “m₂”.

FIG. 6A shows an example wherein the motion vector detecting circuit 24 determines the third center point C₃ which is shifted from the second center point c₂ by twice the vector c₂ m₂ from the second center point c₂ to the second minimum point m₂ in the same way as in FIG. 5A. FIG. 6B shows an example wherein the motion vector detecting circuit 24 determines the third center point C₃ which is shifted from the second center point c₂ in the direction toward the second minimum point m₂ in the same way as shown in FIG. 6A. Furthermore, with the example shown in FIG. 6B, the third center point c₃ is determined so as to include the second minimum point m₂, and so as to suppress redundant search, which has been already performed, as much as possible. This enables block matching for a greater number of search points by determining a suitable detecting direction. FIG. 6C shows an example wherein the motion vector detecting circuit 24 determines the third center point c₃ which is shifted from the first minimum point m₁ in the direction toward the second minimum point m₂. The detection method shown in this example enables detection by shifting the search region in a suitable direction wherein there is a strong likelihood that the prediction macro block will be detected, as well.

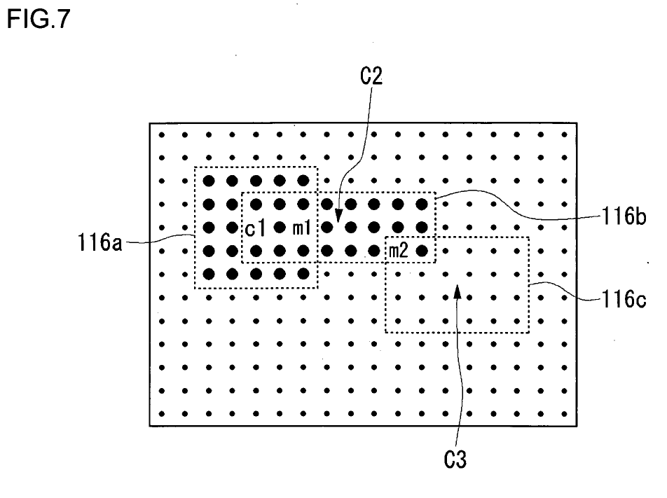

FIG. 7 is also a diagram for describing a motion vector detecting method according to the present embodiment. With an example shown in FIG. 7, the motion vector detecting circuit 24 does not employ a search region with the same shape, but employs a search region with a shape determined based upon predetermined conditions in each stage. For example, the motion vector detecting circuit 24 employs the second search region 116b which has long sides extending along the vector c₁m₁ from the first center point c₁ to the first minimum point m₁. That is to say, the motion vector detecting circuit 24 sets a wider search region in a suitable direction wherein there is a strong likelihood that the prediction macro block will be detected. This improves detection precision and detection speed for detecting the motion vector. Furthermore, the motion vector detecting circuit 24 sets the third detection region 116c to a wider search region in a suitable direction of the vector c₂ m₂ from the second center point c₂ to the second minimum point m₂ in the same way. Note that the shape of the search region is not restricted to a rectangle, rather, the motion vector detecting circuit 24 may employ a search region in a desirable shape.

While description has been made regarding examples with reference to FIGS. 5 through 7 wherein the motion vector detecting circuit 24 determines the next search region based upon the immediately-previous detection results, the motion vector detecting circuit 24 may determine the search region based upon detection results even further in the past than the immediately-previous those. For example, the motion vector detecting circuit 24 may determine the next search region based upon the sum of the vectors cₙmₙ from the n'th center point cₙ to the n'th minimum point mₙ. Furthermore, the motion vector detecting circuit 24 may determine the next search region based upon information regarding motion vectors of frames in the past or in the future, or information regarding the motion vectors of other macro blocks in the same frame. For example, the motion vector detecting circuit 24 may determine the first search region based upon the motion vector of the corresponding macro block in the reference frame. Furthermore, the motion vector detecting circuit 24 may determine subsequent search regions having the longitudinal direction matching the motion vector of the corresponding macro block in the reference frame. Furthermore, the motion vector detecting circuit 24 may determine the search region based upon statistics information regarding the motion vectors of other macro blocks in the same frame. For example, the motion vector detecting circuit 24 may determine a search region based upon the average of the motion vectors of other macro blocks, or may determine a wider search region in the direction of the motion vector of another macro block. Furthermore, the motion vector detecting circuit 24 may determine a search region based upon information other than the motion vectors, e.g., information regarding screen-scrolling or the like. For example, an arrangement may be made wherein, upon acquisition of the information that the screen is being scrolled in the horizontal direction, the motion vector detecting circuit 24 determines a wider search region having the longitudinal direction matching the horizontal direction. As described above, the motion vector detecting circuit 24 may estimate the motion vector based upon various information other than the immediately-previous detection results, thereby enabling higher-speed and higher-precision detection of the motion vector.

The motion vector detecting circuit 24 performs block matching while shifting the search region 116 according to the detection method described above. Upon the (n−1)'th minimum point matching the n'th minimum point, the motion vector detecting circuit 24 determines the macro block represented by the n'th point thus obtained, as the prediction macro block, whereby detection ends. Also, the motion vector detecting circuit 24 may determine ending detection based upon other conditions of ending detection. For example, an arrangement may be made wherein, in the event that the distance between the (n−1)'th minimum point and the n'th minimum point is smaller than a predetermined threshold, the motion vector detecting circuit 24 determines ending detection.

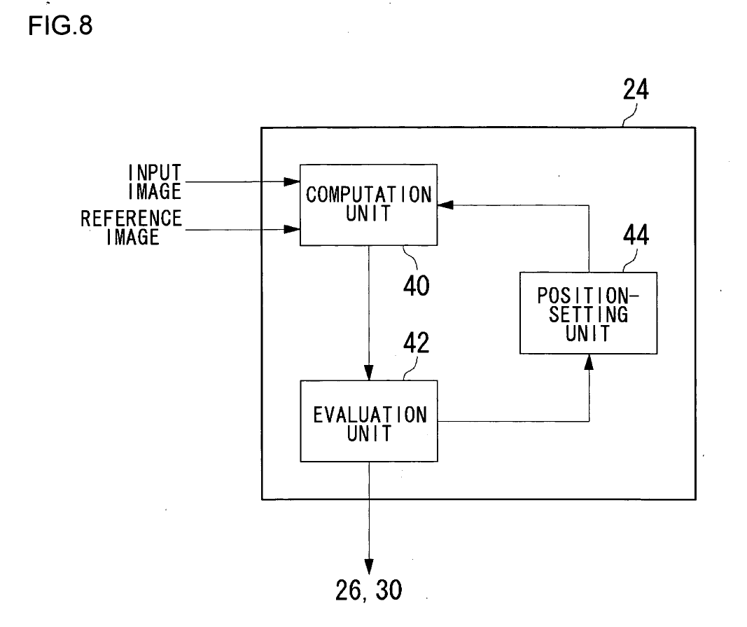

FIG. 8 shows a configuration of the motion vector detecting circuit 24 according to the present embodiment. The motion vector detecting circuit 24 includes a computation unit 40, an evaluation unit 42, and a position-setting unit 44. Such a configuration may be realized in various forms, e.g., by hardware means alone, by software means alone, or by a combination thereof. Specifically, the functions of the motion vector detecting circuit 24 described above are realized by actions of such a configuration.

The computation unit 40 computes block matching between the coding target macro block 102 and each of the multiple computation target macro blocks 112 in parallel. The evaluation unit 42 acquires the computation results obtained by the computation unit 40, and evaluates the computation results. The evaluation unit 42 detects the search point which exhibits the minimum difference from the results of block matching for the multiple computation target macro blocks 112 computed by the computation unit 40, and stores the minimum point in memory or the like. The evaluation unit 42 compares the minimum point obtained in the current computation with the minimum point in the previous computation thus stored. In a case wherein the minimum point in the current computation matches that in the previous computation, the evaluation unit 42 determines this point as the prediction macro block, and transmits the prediction macro block thus determined, to the motion compensation circuit 26 and the coding circuit 30. On the other hand, in a case wherein the minimum point in the current computation does not match that in the previous computation, the evaluation unit 42 stores the new minimum point obtained in the current computation, and instructs the position-setting unit 44 to set the next search region 116. Upon reception of the instructions from the evaluation unit 42, the position-setting unit 44 sets the position of the next search region 116 according to the rules described above.

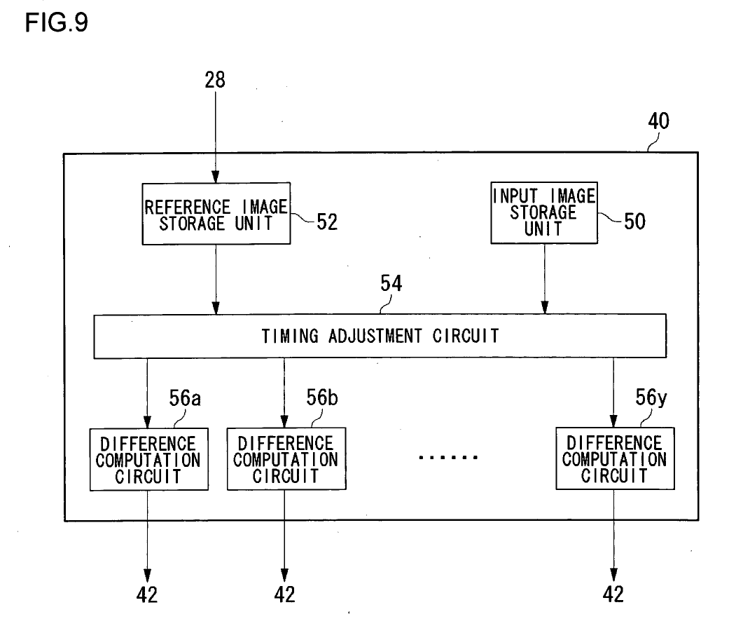

FIG. 9 shows a configuration of the computation unit 40 according to the present embodiment. The computation unit 40 includes an input image storage unit 50, a reference image storage unit 52, a timing adjustment circuit 54, and multiple difference computation circuits 56a through 56y. Such a configuration may be realized in various forms, e.g., by hardware means alone, by software means alone, or by a combination thereof, as well.

The input image storage unit 50 stores the coding target macro block 102 of the input image. The reference image storage unit 52 stores the computation target macro blocks 112 of the reference image. The aforementioned units may be replaced with the frame memory 28, or may be realized using a part of the frame memory 28. The reference image storage unit 52 may store the pixel values of the region 114 as described with reference to FIG. 4. The timing adjustment circuit 54 adjusts the timing for inputting the pixel values of the coding target macro block 102 and the pixel values of the computation target macro blocks 112 to the difference computation circuits 56a through 56y. With the sequential readout of the pixel values of the region 114 stored in the reference image storage unit 52 according to the present embodiment, the timing adjustment circuit 54 adjusts the timing for supplying suitable pixel values to the difference computation circuit 56, which has a function for computation based upon the pixel values thus read out, using a combination of counters and flip-flops, or the like. Specifically, the multiple flip-flops temporarily store the multiple pixel data sets read out from the reference image storage unit 52. The counters are operated, synchronously with the timing of readout of the pixel data from the input image storage unit 50. The pixel data necessary for the current computation is selected from the pixel data stored in the flip-flops, and is output to each difference computation circuit 56, according to the counter values.

Each of the difference computation circuits 56a through 56y computes block matching between the coding target macro block 102 and a respective one of the computation target macro blocks 112a through 112y. Each difference computation circuit 56 may calculate the sum of the absolute differences in the pixel value between the coding target macro block 102 and a respective computation target macro block 112, may calculate the sum of the squares of the differences therebetween, or may calculate a desired value which represents the difference between the images. With conventional detection methods, the same pixel values need to be read out for each computation. With the present embodiment, the pixel values required for block matching are supplied to the multiple difference computation circuits 56a through 56y at the same time, thereby greatly suppressing the number of the times of memory access, and thereby improving processing speed.

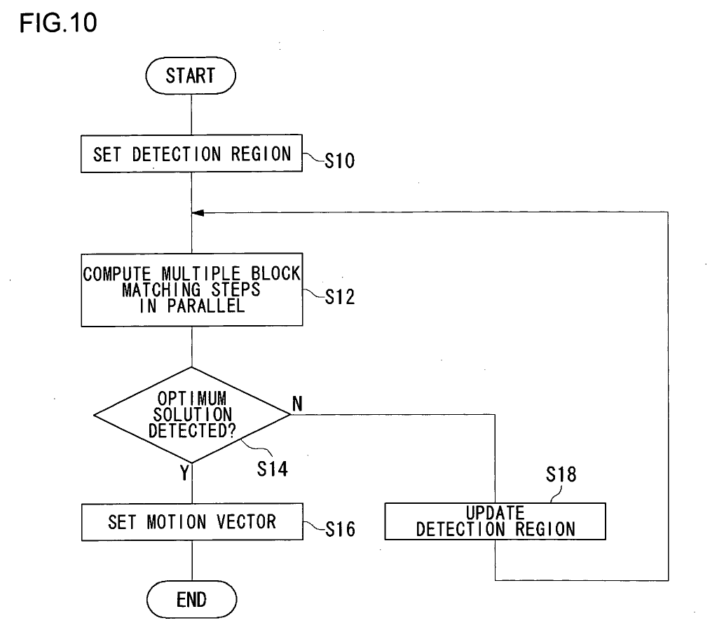

FIG. 10 is a flowchart which shows the procedure of the motion vector detecting method according to the present embodiment. First, the position-setting unit 44 sets the first search region 116 (S10), and the difference computation circuits 56a through 56y compute block matching for the multiple search points included in the search region 116 in parallel (S12). The evaluation unit 42 evaluates the computation results. In a case wherein determination has been made that the optimum solution has been obtained based upon predetermined conditions (in a case of “YES” in S14), the motion vector is determined based upon the optimum solution (S16), whereby detection ends. In a case wherein the evaluation unit 42 has determined that the optimum solution has not been obtained (in a case of “NO” in S14), the position-setting unit 44 updates the search region 116 for the next matching computation (S18), and the difference computation circuits 56a through 56y execute matching computation again (S12).

As described above, description has been made regarding the present invention with reference to the aforementioned embodiments. The above-described embodiments have been described for exemplary purposes only, and are by no means intended to be interpreted restrictively. Rather, it can be readily conceived by those skilled in this art that various modifications may be made by making various combinations of the aforementioned components or the aforementioned processing, which are also encompassed in the technical scope of the present invention.

The motion vector detecting circuit 24 may switch the detection mode between the detection mode according to the present embodiment wherein multiple block matching steps are executed in parallel, and the conventional detection mode. For example, an arrangement may be made wherein, in a case of coding motion images with a large data amount in real time, or with a high frame rate, i.e., in a case which requires high-speed coding processing, multiple difference computation circuits 56 execute block matching in parallel for improving the processing speed. On the other hand, with such an arrangement, in a case of coding motion images with a small data amount, in a case of a mobile device which includes a CPU having relatively low processing performance, or in a case wherein the power consumption of the device should be suppressed, the number of the difference computation circuits 56 which are to be operated is reduced. In order to realize such a technique, the image coding device 10 may include control means for switching the motion-vector detection method, or adjusting the number of the difference computation circuits 56 which are to be operated, based upon information such as the data amount of the motion images, the frame, the processing performance of the device, the operation mode of the device, and so forth.

1. A motion vector detecting device for detecting a motion vector between a first image and a second image serving as a reference image of said first image, including a plurality of computation units for computing matching between a block included in said first image and blocks included in said second image,
wherein said plurality of computation units compute multiple matching steps in parallel.

2. A motion vector detecting device according to claim 1, wherein said plurality of computation units compute multiple matching at the same time.

3. A motion vector detecting device according to claim 1, wherein each of said plurality of computation units computes matching between said first image and a respective one of a plurality of blocks each of which is represented by a search point included in a two-dimensional search region having a predetermined pattern,
wherein said motion vector detecting device further includes: an evaluation unit for evaluating computation results obtained by said plurality of computation units, and detecting a search point which exhibits optimum matching result; and a setting unit for setting search points for which the next matching is to be computed, based upon the evaluation result obtained by said evaluation unit.

4. A motion vector detecting device according to claim 3, wherein said setting unit sets the next search region to a region including the search point which exhibits the optimum matching result,
and wherein the next search points are set to points included in said search region thus determined.

5. A motion vector detecting device according to claim 3, wherein said setting unit sets the next search region by shifting the search region in a direction from the center point of said search region toward the search point which exhibits the optimum matching result.

6. A motion vector detecting device according to claim 4, wherein said setting unit sets the next search region by shifting the search region in a direction from the center point of said search region toward the search point which exhibits the optimum matching result.

7. A motion vector detecting device according to claim 3, wherein said setting unit sets the next search region by shifting the search region in a direction from the search point which exhibits the optimum matching result in the previous computation toward the search point which exhibits the optimum matching result in the current computation.

8. A motion vector detecting device according to claim 4, wherein said setting unit sets the next search region by shifting the search region in a direction from the search point which exhibits the optimum matching result in the previous computation toward the search point which exhibits the optimum matching result in the current computation.

9. A motion vector detecting device according to claim 3, wherein said setting unit sets said search points based upon any one of: evaluation results evaluated by said evaluation unit in detection even further in the past than the immediately-previous detection; the motion vector of other block in said first image; the motion vector of the image even further in the past or in the future than said first image; and information regarding scrolling of said first image.

10. A motion vector detecting device according to claim 4, wherein said setting unit sets said search points based upon any one of: evaluation results evaluated by said evaluation unit in detection even further in the past than the immediately-previous detection; the motion vector of other block in said first image; the motion vector of the image even further in the past or in the future than said first image; and information regarding scrolling of said first image.

11. A motion vector detecting device according to claim 5, wherein said setting unit sets said search points based upon any one of: evaluation results evaluated by said evaluation unit in detection even further in the past than the immediately-previous detection; the motion vector of other block in said first image; the motion vector of the image even further in the past or in the future than said first image; and information regarding scrolling of said first image.

12. A motion vector detecting device according to claim 6, wherein said setting unit sets said search points based upon any one of: evaluation results evaluated by said evaluation unit in detection even further in the past than the immediately-previous detection; the motion vector of other block in said first image; the motion vector of the image even further in the past or in the future than said first image; and information regarding scrolling of said first image.

13. A motion vector detecting device according to claim 7, wherein said setting unit sets said search points based upon any one of: evaluation results evaluated by said evaluation unit in detection even further in the past than the immediately-previous detection; the motion vector of other block in said first image; the motion vector of the image even further in the past or in the future than said first image; and information regarding scrolling of said first image.

14. A motion vector detecting device according to claim 8, wherein said setting unit sets said search points based upon any one of: evaluation results evaluated by said evaluation unit in detection even further in the past than the immediately-previous detection; the motion vector of other block in said first image; the motion vector of the image even further in the past or in the future than said first image; and information regarding scrolling of said first image.

15. A motion vector detecting device according to claim 3, wherein said setting unit determines the shape of said search region based upon any one of: evaluation results evaluated by said evaluation unit; the motion vector of other block in said first image; the motion vector of the image even further in the past or in the future than said first image; and information regarding scrolling of said first image.

16. A motion vector detecting device according to claim 4, wherein said setting unit determines the shape of said search region based upon any one of: evaluation results evaluated by said evaluation unit; the motion vector of other block in said first image; the motion vector of the image even further in the past or in the future than said first image; and information regarding scrolling of said first image.

17. A motion vector detecting device according to claim 5, wherein said setting unit determines the shape of said search region based upon any one of: evaluation results evaluated by said evaluation unit; the motion vector of other block in said first image; the motion vector of the image even further in the past or in the future than said first image; and information regarding scrolling of said first image.

18. A motion vector detecting device according to claim 6, wherein said setting unit determines the shape of said search region based upon any one of: evaluation results evaluated by said evaluation unit; the motion vector of other block in said first image; the motion vector of the image even further in the past or in the future than said first image; and information regarding scrolling of said first image.

19. A motion vector detecting device according to claim 7, wherein said setting unit determines the shape of said search region based upon any one of: evaluation results evaluated by said evaluation unit; the motion vector of other block in said first image; the motion vector of the image even further in the past or in the future than said first image; and information regarding scrolling of said first image.

20. An image coding device for coding motion images so as to create a coded data sequence comprising:
a motion vector detecting unit for detecting a motion vector between a first image forming said motion images and a second image serving as a reference image of said first image; and
a coding unit for coding said first image using said motion vector,
wherein said motion vector detecting unit includes a plurality of computation units for computing matching between said first image and blocks included in said second image,
and wherein said plurality of computation units compute a plurality of matching steps in parallel.

21. An image coding device according to claim 20, wherein said plurality of computation units compute multiple matching at the same time.

22. A method for detecting a motion vector between a first image and a second image serving as said first image comprising:
computing matching between said first image and a plurality of blocks, each of which is represented by a respective one of a plurality of search points included in a two-dimensional search region having a predetermined pattern included in said second image;
estimating computation results obtained in said computation step so as to detect a search point which exhibits optimum matching result; and
setting search points for the next matching computation based upon a detection result obtained in said detection.
